(19) United States
(12) Patent Application Publication
(10) Pub. No.: US 2009/0165085 A1
(43) Pub. Date: Jun. 25, 2009

(54) VECTOR GENERATION DEVICE, VECTOR GENERATING METHOD, AND INTEGRATED CIRCUIT

(75) Inventors: Ken Naka, Tokyo (JP); Kazunori Inoue, Tokyo (JP); Mikio Morioka, Saitama (JP)

Correspondence Address: PEARNE & GORDON LLP, 1801 EAST 9TH STREET, SUITE 1200, CLEVELAND, OH, 44114-3108, US

(73) Assignee: MATSUSHITA ELECTRIC INDUSTRIAL CO., LTD., Kadoma-shi, Osaka (JP)

(21) Appl. No.: 11/568,318

(22) PCT Filed: Feb. 21, 2006
(86) PCT No.: PCT/JP06/03010

§ 371 Date: Oct. 26, 2006

(30) Foreign Application Priority Data
Feb. 25, 2005 (JP) 2005-050937

(51) Int. Cl. H04L 9/32; G06F 17/15; G06F 17/16

(52) U.S. Cl. 726/2; 708/422; 708/424

(57) ABSTRACT

An object of the invention is to provide a vector generation apparatus, a vector generation method, and an integrated circuit for generating data (vector) as a basis for authentication processing such as biometric authentication while protecting information that can be authenticated at high speed using the resources of a server and should be handled as secrete information typified by a biometric template against secondary use.

A terminal 100 includes a reception section 101 for receiving a feature extraction vector as a first vector from the outside; a storage section 102 for storing a biometric template vector as a second vector; a vector computation section 103 for calculating a correlation efficient between the first vector and the second vector and generating a third vector different from the second vector, with the correlation coefficient matching the correlation efficient; and a transmission section 104 for transmitting the third vector to a server 10.

### TECHNICAL FIELD

This invention relates to a vector generation apparatus, a vector generation method, and an integrated circuit for authenticating the validity of the user.

### BACKGROUND ART

In the field of a biometric authentication technology, in recent years, the demand for a biometric authentication technology has begun for the user to carry a security device having a CPU of an IC card, etc., and a tamper-resistant storage area and for verifying the biometric template indicating the biometric features of the user stored in the security device against the face, the fingerprint image, and the voice print of the user acquired from a sensor and authenticating personal identification of the user when the user uses service of electronic money, a commuter pass, an electronic ticket, etc.

Against this backdrop, in recent years, an art of protecting the biometric template has been demanded from the viewpoint of protection of privacy (for example, refer to patent document 1).

The system is made up of an authentication apparatus 2100 for authenticating an operator 2108 and a portable storage section 2106 held by the operator 2108, for example, as shown in FIG. 21.

The authentication apparatus 2100 is made up of a biometric information input section 2101 for reading biometric information from a human being, a reader/writer 2102 for reading and writing data from and to the portable storage section 2106, memory 2103 for storing data, and an authentication section 2104 for making a comparison between the biometric information and a template and authenticating personal identification.

The biometric template is divided into a partial template A 2105 and a partial template B 2107, which are stored in the memory 2104 and the portable storage section 2106.

At the authentication time, in the apparatus, the biometric input section 2101 reads the biometric information of the operator 2108 and passes it to the authentication section 2104, which then combines the partial template A 2105 stored in the memory 2103 and the partial template B 2107 read by the reader/writer 2102 from the portable storage section 2106 into the original template and makes a comparison between the template and the biometric information read from the operator 2108 for authenticating personal identification.

Patent document 1: JP-A-2001-67137

### DISCLOSURE OF THE INVENTION

### Problems to be Solved by the Invention

However, in the authentication apparatus for verifying the biometric template against the biometric information acquired from the biometric input section 2101 in the related art as described above, the biometric template exists in the complete form at the authentication time and therefore if the biometric template leaks, there is a danger that the biometric template may be secondarily used; this is a problem.

To solve this problem, a method of performing authentication processing in the security device carried by the user (corresponding to the portable storage section 2106 in the related art example) is proposed. However, considering the processing capability, the configuration of performing authentication processing using the server resources is a more desirable configuration because the processing can be performed at higher speed.

The invention is intended for solving the problem in the related art and it is an object of the invention to provide a vector generation apparatus, a vector generation method, and an integrated circuit for generating data (vector) as a basis for authentication processing such as biometric authentication while protecting information that can be authenticated at high speed using the resources of a server and should be handled as secrete information typified by a biometric template against secondary use.

### Means for Solving the Problems

A vector generation apparatus of the invention is an apparatus for generating data satisfying a given requirement, the apparatus including a reception section for receiving a first vector R of N (N is a natural number of two or more) dimensions from a server connected to the apparatus so that information can be transmitted; a storage section for storing a second vector T of N dimensions; a vector computation section for calculating a correlation coefficient E between the first vector R and the second vector T and generating a third vector U different from the second vector T, with the correlation coefficient matching the correlation coefficient E; and a transmission section for transmitting the third vector U to the server.

According to the configuration, it is made possible for the outside to check that “the terminal holds the second vector” in a state in which the second vector is protected without being exposed to the outside, and the biometric template that can be authenticated at high speed and is transmitted by the terminal to the outside is converted so that the collation result is maintained in the terminal and it is difficult to restore to the original template and thus can be used only in the authentication on the spot. Therefore, if the provided biometric template leaks from the server, it is difficult to make secondary use of the biometric template for authentication, etc., and safety is provided.

In the vector generation apparatus of the invention, the reception section receives information of the allowable range of the correlation coefficient E, and the vector computation section includes correlation coefficient varying means for varying the correlation coefficient E in response to the allowable range.

According to the configuration, the candidate range if an attempt is made to estimate the vector T from the vector U furthermore widens and it becomes furthermore difficult to estimate the vector T.

In the vector generation apparatus of the invention, the storage section stores history information of the third vector U generated by the vector computation section, and the vector computation section has generated vector dispersion means for controlling so as to generate the third vector U not recorded in the history information.

According to the configuration, it is made difficult to estimate the vector T using analysis of a random number generation method.

In the vector generation apparatus of the invention, the storage section stores vector verification information of information as the criterion for verifying the first vector R, and the vector computation section has vector verification means for verifying the first vector R with the vector verification information as the criterion and changing the generation method of the third vector U in response to the verification result.

According to the configuration, it is made difficult to estimate the vector T from the vector U generated by operating the vector R.

In the vector generation apparatus of the invention, the storage section stores the security level of each component of the first vector R and reception vector control information of information of an action taking method responsive to the security level, and the reception section selects components of the first vector R with the reception vector control information as the criterion.

According to the configuration, the components of the second vector at high security level can be protected preferentially.

A vector generation method of the invention is a vector generation method in an apparatus having a computation function, the vector generation method including the steps executed by the apparatus, of a first step of receiving a first vector R from a server connected to the apparatus so that information can be transmitted; a second step of acquiring a second vector T from a storage section for storing the second vector; a third step of calculating a correlation coefficient E between the first vector R and the second vector T; a fourth step of generating a third vector U different from the second vector T, with the correlation coefficient matching the correlation coefficient E; and a fifth step of transmitting the third vector U to the server.

According to the configuration, the biometric template that can be authenticated at high speed and is transmitted by the terminal to the outside is converted so that the collation result is maintained in the terminal and it is difficult to restore to the original template and thus can be used only in the authentication on the spot. Therefore, if the provided biometric template leaks from the server, it is difficult to make secondary use of the biometric template for authentication, etc., and safety is provided.

An integrated circuit of the invention is an integrated circuit for installing a vector generation apparatus for generating data satisfying a given requirement, and the vector generation apparatus includes a storage section for storing a second vector T of N dimensions; and a vector computation section for calculating a correlation coefficient E between a first vector R of N (N is a natural number of two or more) dimensions received from a server connected to the apparatus so that information can be transmitted and the second vector T and generating a third vector U different from the second vector T, with the correlation coefficient matching the correlation coefficient E.

According to the configuration, the biometric template that can be authenticated at high speed and is transmitted by the terminal to the outside is converted so that the collation result is maintained in the terminal and it is difficult to restore to the original template and thus can be used only in the authentication on the spot. Therefore, if the provided biometric template leaks from the server, it is difficult to make secondary use of the biometric template for authentication, etc., and safety is provided.

### ADVANTAGES OF THE INVENTION

The biometric template that can be authenticated at high speed and is transmitted by the terminal to the outside is converted so that the collation result is maintained in the terminal and it is difficult to restore to the original template and thus can be used only in the authentication on the spot. Therefore, the invention has the advantage that if the provided biometric template leaks from the server, it is difficult to make secondary use of the biometric template for authentication, etc., and safety is provided.

### BRIEF DESCRIPTION OF THE DRAWINGS

FIG. 1 is a block diagram to show the system configuration of a vector generation apparatus in a first embodiment of the invention.

FIG. 2 is a flowchart of processing in the first embodiment of the invention.

FIG. 3 is a detailed block diagram of a terminal in the first embodiment of the invention.

FIG. 4 is a flowchart of processing of finding a vector Tr in the first embodiment of the invention.

FIG. 5 is a block diagram to show the system configuration of a vector generation apparatus in a second embodiment of the invention.

FIG. 6 is a flowchart of processing of finding a vector Tr in the second embodiment of the invention.

FIG. 7 is a block diagram to show the system configuration of a vector generation apparatus in a third embodiment of the invention.

FIG. 8 is a flowchart of processing in the third embodiment of the invention.

FIG. 9 is a flowchart of processing of varying a correlation coefficient in the third embodiment of the invention.

FIG. 10 is a block diagram to show the system configuration of a vector generation apparatus in a fourth embodiment of the invention.

FIG. 11 is a flowchart of processing in the fourth embodiment of the invention.

FIG. 12 is a drawing to show a specific example of history information in the fourth embodiment of the invention.

FIG. 13 is a block diagram to show the system configuration of a vector generation apparatus in a fifth embodiment of the invention.

FIG. 14 is a flowchart of processing in the fifth embodiment of the invention.

FIG. 15 is a drawing to show a specific example of vector verification information in the fifth embodiment of the invention.

FIG. 16 is a block diagram to show the system configuration of a vector generation apparatus in a sixth embodiment of the invention.

FIG. 17 is a flowchart of processing in the sixth embodiment of the invention.

FIG. 18 is a drawing to show a specific example of reception vector control information in the sixth embodiment of the invention.

FIG. 19 is a block diagram to show the system configuration of the vector generation apparatus when a vector computation section and a storage section are LSI in the first embodiment of the invention.

FIG. 20 is a block diagram to show the system configuration of the vector generation apparatus when a vector computation section and a storage section are LSI in the second embodiment of the invention.

FIG. 21 is a block diagram to show the system configuration in a related art example.

### DESCRIPTION OF REFERENCE NUMERALS

10 External machine
100 Terminal
101 Reception section
102 Storage section
103 Vector computation section
104 Transmission section
300 Correlation coefficient calculation means
301 Vector replacement means
302 Vector function storage means
303 Vector computation means
304 Vector combining means
305 Template vector
500 Vector computation section
501 Correlation coefficient calculation means
502 Vector replacement means
503 Vector function storage means
504 Vector computation means
505 Vector combining means
700 Reception section
701 Vector computation section
702 Correlation coefficient varying means
800 Step “reception of allowable range of correlation coefficient”
801 Step “varying correlation coefficient”
1000 Vector computation section
1001 Generated vector dispersion means
1002 History information
1200 Identification number
1201 Value
1202 First row of history information
1301 Vector verification information
1302 Vector verification means
1303 Vector computation section
1400 Step “acquisition of vector verification information”
1500 Threshold value
1501 Number of values
1600 Reception vector control information
1601 Reception section
1700 Step “reception vector control”
1800 Absolute reception component
1801 Component priority
1802 Identification number
1900 LSI
2000 LSI
2100 Authentication apparatus
2101 Biometric information input section
2102 Reader/writer
2103 Memory
2104 Authentication section
2105 Partial template A
2106 Portable storage section
2107 Partial template B

### BEST MODE FOR CARRYING OUT THE INVENTION

Referring now to the accompanying drawings, there are shown preferred embodiments of the invention.

### First Embodiment

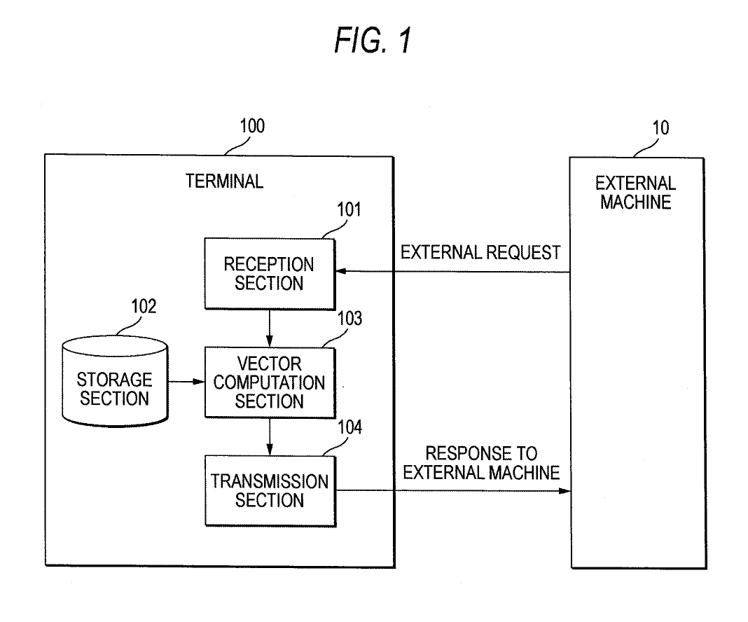

FIG. 1 shows the system configuration of a vector generation apparatus in a first embodiment of the invention.

A terminal 100 is a vector generation apparatus holding a vector whose contents should be prevented from being known by an external machine; it is connected to a server so as to be able to transmit information thereto.

Upon reception of a request for checking whether or not the terminal has the vector by calculating and checking the correlation coefficient with the vector held by an external machine from the external machine, the terminal 100 generates a new vector with the same calculation result, the new vector from which the original vector cannot be identified matching the calculation method of the correlation coefficient in external machine (for example, authentication machine) 10, and transmits the generated vector to the external machine 10.

The external machine 10 receives the new vector, calculates the correlation coefficient, and determines whether or not “the terminal 100 holds the vector.”

The terminal 100 is made up of a reception section 101 for receiving a vector using a communication network from the outside, a storage section 102 for storing a vector, a vector computation section 103 for calculating the correlation coefficient between the two vectors and generating a new vector matching the correlation coefficient, and a transmission section 104 for transmitting the vector to the outside.

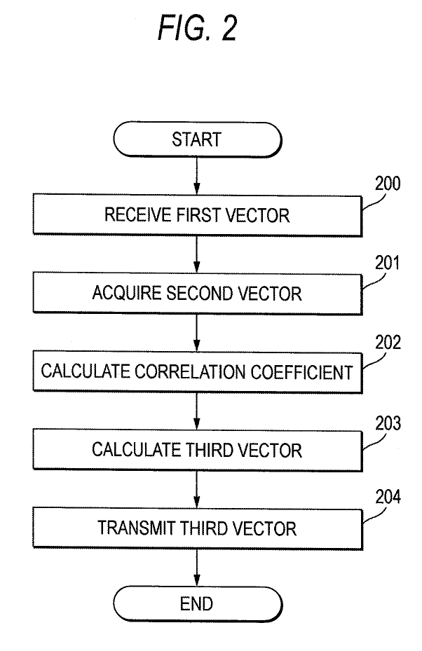

FIG. 2 is a flowchart to show an outline of a processing flow of the embodiment.

In reception of a first vector at step 200, the reception section 101 receives a first vector using a communication network from the outside and passes the vector to the vector computation section 103.

In acquisition of a second vector at step 201, the vector computation section 103 acquires a second vector from the storage section 102.

In calculation of a correlation coefficient at step 202, the vector computation section 103 calculates the correlation coefficient between the first vector and the second vector using a correlation coefficient calculation function.

In calculation of a third vector at step 203, the vector computation section 103 generates a new third vector similar to the first vector matching the correlation coefficient between the first vector and the second vector.

In transmission of the third vector at step 204, the generated third vector is transmitted to the outside.

The terminal 100 is a mobile terminal such as a mobile telephone or a PDA (Personal Digital Assistant), a portable storage device such as an IC (Integrated Circuit) card, a personal computer, or the like, for example.

If the terminal is a mobile terminal, the storage section 102 is implemented as nonvolatile memory of flash memory, etc., the vector computation section 103 is made up of a CPU, ROM, and RAM, and the reception section 101 is made up of an antenna, an RF section, and a wireless communication control circuit for communicating with an external network.

If the terminal is a portable storage device, the storage section 102 is implemented as nonvolatile memory of flash memory, etc., the vector computation section 103 is made up of a CPU, ROM, and RAM, and the reception section 101 is made up of a contact communication interface, a noncontact communication interface for communicating with an external network.

If the terminal is a personal computer, the storage section 102 is implemented as an HDD, the vector computation section 103 is made up of a CPU and memory, and the reception section 101 is made up of a modem and a network card for communicating with an external network, an RF section for conducting wireless communications, a card including a wireless communication control circuit, and a USB device.

Basic software such as an OS is stored in the ROM and is executed by the CPU using the RAM, whereby a mobile terminal, a portable storage device, or a personal computer executing various software programs stored in the storage section 102, the ROM is implemented.

Next, vectors will be discussed. In the embodiment, the vector refers to a string of the extraction values of the biometric feature amounts of a face, a fingerprint, a palmar vein, etc., used for biometric authentication.

Here, the vectors will be discussed by taking a method of using a unique face, one of biometric authentication algorithms as an example.

Let an average face of a face image provided by averaging a plurality of face image samples be μ. For example, if μ is a 128*128-pixel monochrome gray-scale image, it is a matrix with 128 rows and 128 columns with the pixels as the elements.

The ith normal orthogonal basis is represented as Φᵢ. This Φᵢ is found by conducting a main component analysis on a set of face images for learning. Φᵢ is also a matrix of the same dimensions as μ.

Let a face image acquired from one user be a matrix A. If the coefficient put on each Φᵢ if the matrix A is represented by μ and N Φᵢ is bᵢ, one image A is represented by the following expression:

[Expression 1]

$$A = μ + {\sum }_{i = 1}^{N} {b}_{i} * {φ}_{i}$$

Vector B with b_{N} represented as

$$( \begin{matrix}{b}_{1} \\ {b}_{2} \\ ⋮ \\ {b}_{n}\end{matrix} )$$

from b₁ in the above-mentioned expression is a vector in the embodiment.

This vector involves two types. One vector is as follows: When an external party of a kiosk terminal, a service providing server, etc., judges whether or not one user is the person in question, a face image of the biometric information of the user is acquired from a sensor and a vector of the feature amounts is extracted.

The other vector is a vector retained in the storage section 102 by performing previous registration processing and used as the criterion for judging whether or not one user is the person in question, and is called biometric template. A comparison is made between the two types of vector information, whereby it is made possible to judge whether or not one user is the person in question.

In the embodiment, the former vector is called feature extraction vector and the latter vector is called template vector.

The first vector received by the reception section 101 described above corresponds to the feature extraction vector and the second vector stored in the storage section 102 the latter vector corresponds to the template vector.

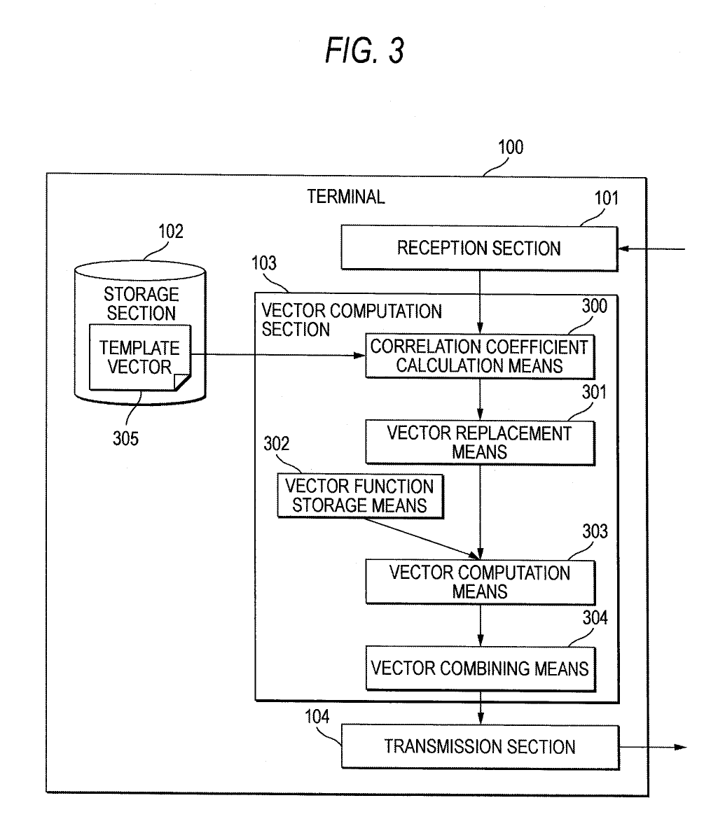

Next, the operation of the vector computation section 103 will be discussed in detail. FIG. 3 shows the detailed configuration.

The vector computation section 103 is made up of correlation coefficient calculation means 300 for calculating correlation coefficient E=F(R, T) using a function V=F(X, Y) for calculating the correlation coefficient with two vectors X and Y as input from a feature extraction vector R received from the outside and a template vector T stored in the storage section 102, vector replacement means 301 for selecting an n-dimensional vector Tₙ with any n of template vector as the elements, replacing the vector with an n-dimensional vector Tᵣ different from the original template vector Tₙ, and replacing an (N−n)-dimensional vector T_{N-n} having other (N−n) as the elements with an (N−n)-dimensional variable vector T_{y} to generate an N-dimensional vector U, vector function storage means 302 for storing a function G to find the variable vector T_{y} satisfying a relational expression E=F(R, U), vector computation means 303 for calculating a vector W=G(E, R, Tr) with the correlation coefficient E, the feature extraction vector R, and the n-dimensional partial vector Tᵣ as variables of the vector function G, and vector combining means 304 for replacing the variable vector Ty with the vector W to generate the vector U. The vector U corresponds to the third vector described above.

Next, the correlation coefficient will be discussed.

The correlation coefficient in the embodiment represents the similarity between two vectors, such as a distance or an inner product.

To adopt the distance, basically the sum of the squares of the component differences between the vectors is used and whether or not it is close to 0, etc., is used as the determination criterion. In the embodiment, the expression is

E=∥T−R∥² or E=∥U−R∥²

Letting the ith components of T, R, and U be tᵢᵢ, rᵢᵢ, and uᵢᵢ, the expression becomes as follows:

[Expression 2]

$$E = {\sum }_{i = 1}^{N} {( {t}_{i} - {r}_{i} )}^{2} or E = {\sum }_{i = 1}^{N} {( {u}_{i} - {r}_{i} )}^{2}$$

Calculating the correlation coefficient E using the expression is processing of the correlation coefficient calculation means 300.

Next, the partial vector Tᵣ will be discussed. Let the ith component of Tᵣ be tᵣᵢ.

[Expression 3]

In the embodiment, assuming that n=N−1,

$${T}_{n} = ( \begin{matrix}{t}_{1} \\ {t}_{2} \\ ⋮ \\ {t}_{N - 1}\end{matrix} ) , {T}_{r} = ( \begin{matrix}{t}_{r 1} \\ {t}_{r 2} \\ ⋮ \\ {t}_{rN - 1}\end{matrix} ) and {T}_{y} = ( {t}_{y 1} ) .$$

If U is represented by Tᵣ, T_{y},

$$( \begin{matrix}{u}_{1} \\ {u}_{2} \\ ⋮ \\ {u}_{N - 1} \\ {u}_{N}\end{matrix} ) = ( \begin{matrix}{t}_{r 1} \\ {t}_{r 2} \\ ⋮ \\ {t}_{rN - 1} \\ {t}_{y 1}\end{matrix} ) .$$

The values are determined in order so that the value of the sum of the squares of the component differences between the vector Tᵣ and the feature extraction vector R does not exceed the value of the correlation coefficient.

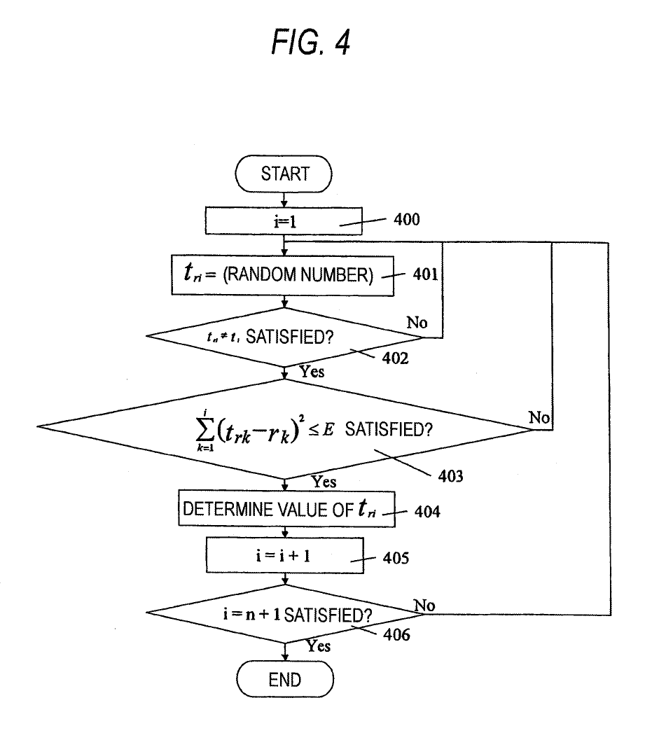

FIG. 4 shows a processing flow indicating how to find each component of Tᵣ.

At step 400, first the value of which component is to be determined is determined. In the embodiment, the values are determined in order starting at the first component by way of example, and i is set to 1.

At step 401, a random number is generated to set tentative tᵣᵢ. Basically, tᵣᵢ is a real number.

At step 402, a check is made so that the value determined tentatively as the value of the component of Tᵣ does not match the value of the essential component of T.

If they do not match, the process goes to step 403; if they match, the process returns to step 401.

At step 403, a check is made to see if the sum of the squares of the differences between Tᵣ and R exceeds the correlation coefficient.

[Expression 4]

Here, to determine whether or not the sum up to the component Tᵣ to be determined,

$${\sum }_{k = 1}^{i} {( {t}_{tk} - {r}_{k} )}^{2}$$

exceeds correlation coefficient E,

$${\sum }_{k = 1}^{i} {( {t}_{tk} - {r}_{k} )}^{2}$$

≦E is checked.

If the sum does not exceed the correlation coefficient, the process goes to step 404; if the sum exceeds the correlation coefficient, the process returns to step 401.

At step 404, the tentatively determined value of tᵣᵢ is adopted as the determined value.

At step 405, one is added to i to determine the next component. For the determination order, any other method than that of adding one at a time may be used.

At step 406, whether or not the values of all components of T are determined is checked.

Since Tᵣ is an n-dimensional vector, if i is n+1, it is seen that the values of all components are determined.

If the values of all components are determined, the process is terminated; if the values of all components are not determined, the process returns to step 401.

The flow to find each component of Tᵣ has been described.

Processing of determining Tᵣ and replacing the remaining portion with the variable vector T_{y} is processing of the vector replacement means 301. The components of T_{y} are found with the vector function G described below.

The vector function G will be discussed:

The vector function G is a function to calculate a vector W from the correlation coefficient E, the feature extraction vector R, and the n-dimensional partial vector Tᵣ.

[Expression 5]

$$( \begin{matrix}{u}_{1} \\ {u}_{2} \\ ⋮ \\ {u}_{N - 1} \\ {u}_{N}\end{matrix} ) = ( \begin{matrix}{t}_{r 1} \\ {t}_{r 2} \\ ⋮ \\ {t}_{rN - 1} \\ {t}_{y 1}\end{matrix} ) , E = {\sum }_{i = 1}^{N} {( {u}_{i} - {r}_{i} )}^{2}$$

and T_{y}=W and therefore if the vector function G to find the components of the vector U are represented by E, R, and Tᵣ components, it becomes as follows:

$$W = ( {w}_{1} ) = G ( E , R , {T}_{r} ) = ( {r}_{N} \pm \sqrt{E - {\sum }_{i = 1}^{N - 1} {( {t}_{ri} - {r}_{i} )}^{2}} )$$

$$where {w}_{1} \neq {t}_{N}$$

Using the expression, finding the vector W is processing of the vector computation means 303.

From the result and T_{y}=W, the components of U are found as follows:

[Expression 6]

$$U = ( \begin{matrix}{u}_{1} \\ {u}_{2} \\ ⋮ \\ {u}_{N - 1} \\ {u}_{N}\end{matrix} ) = ( \begin{matrix}{t}_{r 1} \\ {t}_{r 2} \\ ⋮ \\ {t}_{rN - 1} \\ {r}_{N} \pm \sqrt{E - {\sum }_{i = 1}^{N - 1} {( {t}_{ri} - {r}_{i} )}^{2}}\end{matrix} )$$

Finding U is processing of the vector combining means 304.

In the embodiment, to find the correlation coefficient according to the distance, u₁ to U_{N-1} is tᵣ₁ to t_{rN-1}, but any N−1 elements of the vector U may be the components of Tᵣ and the remaining elements may be T_{y}.

In the embodiment, the values are determined in order starting at tᵣ₁, but the determination order may be any and the values may be determined so that the value of the sum of the squares of the differences does not exceed the value of the correlation coefficient. Finally, the correlation coefficient of U and R the correlation coefficient of T and R may match.

The case of determining according to the distance has been described.

Next, the case of determining according to the distance will be discussed by taking specific values as an example.

[Expression 7]

If T and R are

$$T = ( \begin{matrix}1 \\ 2 \\ 3 \\ 4\end{matrix} ) and R = ( \begin{matrix}2 \\ 3 \\ 4 \\ 5\end{matrix} ) , ( \begin{matrix}{u}_{1} \\ {u}_{2} \\ {u}_{3} \\ {u}_{4}\end{matrix} ) = ( \begin{matrix}{t}_{r 1} \\ {t}_{r 2} \\ {t}_{r 3} \\ {t}_{y 1}\end{matrix} )$$

is set.

The correlation coefficient E becomes E=(1−2)²+(2−3)²+(3⁻⁴)²+(4−5)²=4.

The components of Tᵣ are found in order.

If tᵣ₁=3,

$${\sum }_{k = 1}^{1} {( {t}_{tk} - {r}_{k} )}^{2} = {( 3 - 2 )}^{2} = 1 \leq E = 4$$

and the condition is satisfied and thus tᵣ₁ is determined 3.

Next, if

$${t}_{r 2} = 4 , {\sum }_{k = 1}^{2} {( {t}_{tk} - {r}_{k} )}^{2} = {( 3 - 2 )}^{2} + {( 4 - 3 )}^{2} = 2 \leq E = 4$$

and the condition is satisfied and thus tᵣ₂ is determined 4.

Next,

$$\begin{matrix}{t}_{r 3} = 4 , {\sum }_{k = 1}^{3} {( {t}_{tk} - {r}_{k} )}^{2} \\ = {( 3 - 2 )}^{2} + {( 4 - 3 )}^{2} + {( 4 - 4 )}^{2} \\ = 2 \leq E \\ = 4\end{matrix}$$

and the condition is satisfied and thus tᵣ₂ is determined 4.

Next,

$$\begin{matrix}W = ( w 1 ) \\ = G ( E , R , {T}_{r} ) \\ = ( {r}_{N} \pm \sqrt{E - {\sum }_{i = 1}^{N - 1} {( {t}_{ri} - {r}_{i} )}^{2}} ) \\ = 5 \pm \sqrt{4 - 2} \\ = 5 \pm \sqrt{2}\end{matrix} \\ Therefore , U = ( \begin{matrix}3 \\ 4 \\ 5 \\ 5 \pm \sqrt{2}\end{matrix} ) . \qquad$$

If the correlation coefficient is found,

$$\begin{matrix}{\sum }_{i = 1}^{4} {( {t}_{ti} - {r}_{i} )}^{2} = {( 3 - 2 )}^{2} + {( 4 - 3 )}^{2} + {( 4 - 4 )}^{2} + {( 5 \pm √ 2 - 5 )}^{2} \\ = 1 + 1 + 0 + 2 \\ = 4 \\ = E\end{matrix}$$

and it can be checked that the value of the correlation coefficient is maintained.

The specific example has been described.

In the embodiment, the feature extraction vector R is described as an N-dimensional reception pattern, but reception of only the portion of dimensions less than the N dimensions is also possible. In such a case, a vector is generated for the received portion according to the method described in the embodiment.

In the embodiment, the method of using a random number and determining in order is adopted as the determining method of the components of the vector U, but the method of finding the vector U is not limited to it. For example, if the processing capability of the terminal 100 is low, a method of finding each uᵢ from an expression shown in (Expression 9) assuming that the terms shown in (Expression 8) equal is adopted, so that the processing can also be executed in a low-speed terminal with small memory.

[Expression 8]

$$E = {\sum }_{i = 1}^{N} {( {u}_{i} - {r}_{i} )}^{2}$$

(uᵢ−rᵢ)²=E/N [Expression 9]

As the processing described above is performed, the vector U with the same correlation coefficient is generated and is transmitted to an external machine, whereby it is made possible for the external machine to check that “the terminal holds the vector T” in a state in which the vector T of secret information is protected without being exposed to the outside.

Particularly, to apply to biometric authentication, it is made possible to conduct biometric authentication in a state in which the biometric template hard to invalidate if it leaks is protected without being exposed to the outside.

The storage section 102 and the vector computation section 103 typically are implemented as an LSI 1900 of an integrated circuit, as shown in FIG. 19. They may be put into one chip separately or may be put into one chip so as to contain some or all.

Here, an LSI is adopted, but an IC, a system LSI, a super LSI, or an ultra-LSI may be called depending on the integration scale difference.

The technique of putting into an integrated circuit is not limited to LSI and the sections may be implemented as a dedicated circuit or a general-purpose processor. An FPGA (Field Programmable Gate Array) that can be programmed after LSI is manufactured or a dynamic configurable processor wherein connection and setting of circuit cells in LSI can be dynamically reconfigured may be used.

Further, if a technology of putting into an integrated circuit replacing LSI advents because of the progress of the semiconductor technology or according to a derived different technology, the technology may be used to integrate the functional blocks, of course. It is possible to apply a biotechnology, etc., as a possibility.

### Second Embodiment

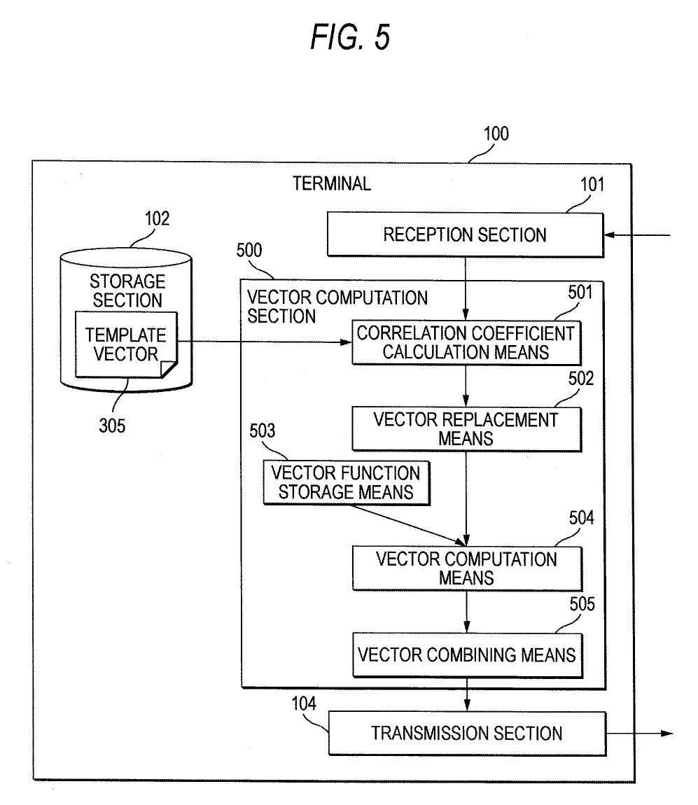

FIG. 5 shows the system configuration of a vector generation apparatus in a second embodiment of the invention.

The embodiment is almost the same as the first embodiment except that the inner product is used as the criterion for determining the similarity of vectors.

A terminal 100 differs from the above-described terminal in a vector computation section 500 for calculating a correlation coefficient using the inner product between two vectors and generating a new vector matching the correlation coefficient.

The vector computation section 500 differs from the above-described vector computation section in means making up the vector computation section. That is, correlation coefficient calculation means 501 for calculating correlation coefficient E=F(R, T) using a function V=F(X, Y) for calculating the correlation coefficient using the inner product, vector replacement means 502 for selecting an n-dimensional vector Tₙ with any n of template vector as the elements, replacing the vector with an n-dimensional vector Tᵣ different from the original template vector Tₙ using the inner product as the determination criterion, and replacing an (N−n)-dimensional vector T_{N-n} having other (N−n) as the elements with an (N-n)-dimensional variable vector T_{y} to generate an N-dimensional vector U, vector function storage means 503 for storing a function G to find the variable vector T_{y} satisfying relational expression E=F(R, U) using the inner product, vector computation means 504 for calculating vector W=G(E, T, R, Tr) with the correlation coefficient E, vector T, the feature extraction vector R, and the n-dimensional partial vector Tᵣ as variables of the vector function G, and vector combining means 505 for replacing the variable vector Ty with the vector W to generate the vector U differ from the means of the first embodiment.

Next, the case where the inner product is used as the correlation coefficient will be specifically discussed.

An example is shown below: To use the inner product as the determination criterion, whether or not the angle between vectors is close to 0, etc., is used as the determination criterion.

In the embodiment, expression cos θ=T·R/∥T∥∥R∥ may be used as the determination criterion in some cases. Since T is converted into a new vector U, ∥R∥ of denominator here does not change in the value and therefore is omitted and E=F(R, T)=R·T=F(R, U)=R·U under condition ∥U∥=∥T∥. Letting the ith components of T, R, and U be tᵢ, rᵢ, and uᵢ, the correlation coefficient is represented by the following expression:

[Expression 10]

$$E = F ( R , T ) = {\sum }_{i = 1}^{N} {t}_{i} * {r}_{i} or$$

$$E = F ( R , U ) = {\sum }_{i = 1}^{N} {u}_{i} * {r}_{i}$$

Calculating the correlation coefficient E using the expression is processing of the correlation coefficient calculation means 501.

Next, the partial vector Tᵣ will be discussed. Let the ith component of Tᵣ be tᵣᵢ.

[Expression 11]

In the embodiment, assuming that

$$n = N - 2 , {T}_{n} = ( \begin{matrix}{t}_{1} \\ {t}_{2} \\ ⋮ \\ {t}_{N - 2}\end{matrix} ) , {T}_{r} = ( \begin{matrix}{t}_{r 1} \\ {t}_{r 2} \\ ⋮ \\ {t}_{rN - 2}\end{matrix} ) , and {T}_{y} = ( \begin{matrix}{t}_{y 1} \\ {t}_{y 2}\end{matrix} ) .$$

If U is represented by Tᵣ, T_{y},

$$( \begin{matrix}{u}_{1} \\ {u}_{2} \\ ⋮ \\ {u}_{N - 2} \\ {u}_{N - 1} \\ {u}_{N}\end{matrix} ) = ( \begin{matrix}{t}_{r 1} \\ {t}_{r 2} \\ ⋮ \\ {t}_{rN - 2} \\ {t}_{y 1} \\ {t}_{y 2}\end{matrix} ) .$$

The values are determined in order so that the sum of the products of the components of the vector Tᵣ and the feature extraction vector R does not exceed the value of the correlation coefficient and that the size does not exceed the size of the vector T.

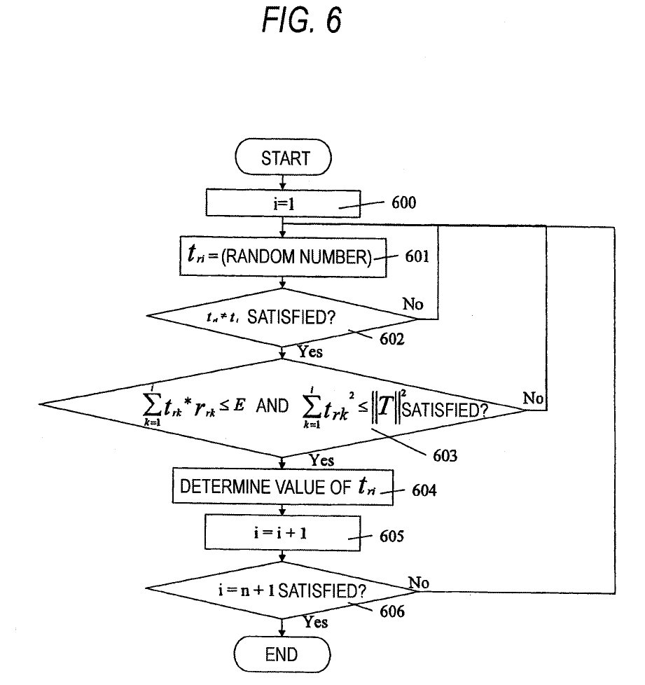

FIG. 6 shows a processing flow indicating how to find each component of Tᵣ.

The basic flow is the same as steps 400 to 406 in FIG. 4. However, steps 403 and 603 differ.

At step 603, a check is made to see if the sum of the inner products of Tᵣ and R exceeds the correlation coefficient.

[Expression 12]

Here, to determine whether or not the sum up to the component Tᵣ to be determined,

$${\sum }_{k = 1}^{l} {t}_{tk} * {r}_{k}$$

exceeds correlation coefficient

$${\sum }_{k = 1}^{l} {t}_{tk} * {r}_{k} \leq E$$

is checked. Further, to determine whether or not the size of Tᵣ exceeds T,

$${\sum }_{k = 1}^{l} {t}_{tk}^{2} \leq {‖ T ‖}^{2}$$

is checked.

If both are satisfied, the process goes to step 604; if not satisfied, the process returns to step 601.

Processing of determining Tᵣ and replacing the remaining portion with the variable vector T_{y} is processing of the vector replacement means 502. The components of T_{y} are found with the vector function G described below.

The vector function G will be discussed:

The vector function G is a function to calculate a vector W from the correlation coefficient E, the feature extraction vector R, and the n-dimensional partial vector Tᵣ.

[Expression 13]

Since Tᵣ to be found is a two-dimensional vector,

$$W = ( \begin{matrix}{w}_{1} \\ {w}_{2}\end{matrix} )$$

is set.

$$( \begin{matrix}{u}_{1} \\ {u}_{2} \\ ⋮ \\ {u}_{N - 2} \\ {u}_{N - 1} \\ {u}_{N}\end{matrix} ) = ( \begin{matrix}{t}_{r 1} \\ {t}_{r 2} \\ ⋮ \\ {t}_{rN - 2} \\ {t}_{y 1} \\ {t}_{y 2}\end{matrix} ) and E = F ( R , U ) = {\sum }_{i = 1}^{N} {u}_{i} * {r}_{i}$$

and U=∥T∥ and T_{y}=W and therefore if the vector function G to find the components of the vector U are represented by E, T, R, and Tᵣ components, it becomes as follows:

$$\begin{matrix}( \begin{matrix}{w}_{1} \\ {w}_{2}\end{matrix} ) = G ( E , T , R , {T}_{r} ) \\ = ( \begin{matrix}( E - {\sum }_{i = 1}^{N - 2} {t}_{ri} * {r}_{i} ) * {r}_{N - 1} \pm {r}_{N} * \frac{\sqrt{\begin{matrix}( {r}_{N - 1}^{2} + {r}_{N}^{2} ) * \\ ( {‖ T ‖}^{2} - {\sum }_{i = 1}^{N - 2} {t}_{ri}^{2} ) - \\ {( E - {\sum }_{i = 1}^{N - 2} {t}_{ri} * {r}_{i} )}^{2}\end{matrix}}}{{r}_{N - 1}^{2} + {r}_{N}^{2}} \pm \\ \sqrt{( {‖ T ‖}^{2} - {\sum }_{i = 1}^{N - 2} {t}_{ri}^{2} ) - {w}_{1}^{2}} or \frac{\begin{matrix}( E - {\sum }_{i = 1}^{N - 2} {t}_{ri} * {r}_{i} ) - \\ {r}_{N - 1} * {w}_{1}\end{matrix}}{{r}_{N}}\end{matrix} )\end{matrix}$$

Using the expression, finding the vector W is processing of the vector computation means 504.

To find as a real number, the components need to be determined so that the value in the square root becomes 0 or more. To allow an imaginary number, no problem is involved.

From the result and T_{y}=W, the components of U are found as follows:

[Expression 14]

$$\begin{matrix}U = ( \begin{matrix}{u}_{1} \\ {u}_{2} \\ ⋮ \\ {u}_{N - 2} \\ {u}_{N - 1} \\ {u}_{N}\end{matrix} ) \\ = ( \begin{matrix}{t}_{r 1} \\ {t}_{r 2} \\ ⋮ \\ {t}_{rN - 2} \\ \frac{( E - {\sum }_{i = 1}^{N - 2} {t}_{ri} * {r}_{i} ) * {r}_{N - 1} \pm \sqrt{\begin{matrix}( {r}_{N - 1}^{2} + {r}_{N}^{2} ) * \\ ( {‖ T ‖}^{2} - {\sum }_{i = 1}^{N - 2} {t}_{ri}^{2} ) - \\ {( E - {\sum }_{i = 1}^{N - 2} {t}_{ri} * {r}_{i} )}^{2}\end{matrix}}}{{r}_{N - 1}^{2} + {r}_{N}^{2}} \pm \\ \sqrt{( {‖ T ‖}^{2} - {\sum }_{i = 1}^{N - 2} {t}_{ri}^{2} ) - {w}_{1}^{2}} or \frac{\begin{matrix}( E - {\sum }_{i = 1}^{N - 2} {t}_{ri} * {r}_{i} ) - \\ {r}_{N - 1} * {w}_{1}\end{matrix}}{{r}_{N}}\end{matrix} )\end{matrix}$$

Finding U is processing of the vector combining means 505.

In the embodiment, to use the inner product for calculating the correlation coefficient, u₁ to u_{N-2} is tᵣ₁ to t_{rN-2}, but any elements of the vector U may be the components of Tᵣ and the remaining elements may be T_{y}.

In the embodiment, the values are determined in order starting at tᵣ₁, but the determination order may be any and the values may be determined so that the value of the sum of the inner products does not exceed the value of the correlation coefficient and that the size of the vector does not exceed the size of the vector T. Finally, the correlation coefficient of U and R, the correlation coefficient of T and R, and the sizes of U and T may match.

Basically, tᵣ₁ is found as a real number, but if an imaginary number is allowed, tᵣ₁ may be an imaginary number.

In this case, the need for determining as to the inner product and the size under the condition at step 603 is eliminated.

As another example, to simply use the inner product value only for making a determination, U may be calculated so as to maintain the inner product value.

The case of determining according to the inner product has been described.

In the embodiment, the feature extraction vector R is described as an N-dimensional reception pattern, but reception of only the portion of dimensions less than the N dimensions is also possible.

In such a case, a vector is generated for the received portion according to the method described in the embodiment.

As the processing described above is performed, the vector U with the same correlation coefficient is generated and is transmitted to the outside, whereby it is made possible for the outside to check that “the terminal holds the vector T” in a state in which the vector T is protected without being exposed to the outside.

Particularly, to apply to biometric authentication, it is made possible to conduct biometric authentication in a state in which the biometric template hard to invalidate if it leaks is protected without being exposed to the outside. It is made possible to conduct biometric authentication in a state in which the biometric template hard to invalidate if it leaks is protected without being exposed to the outside.

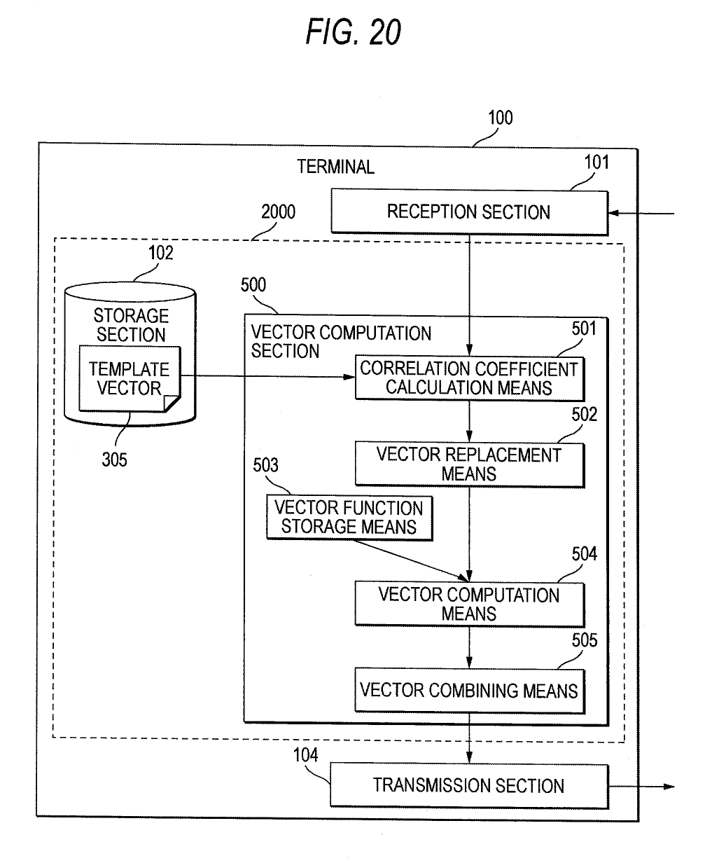

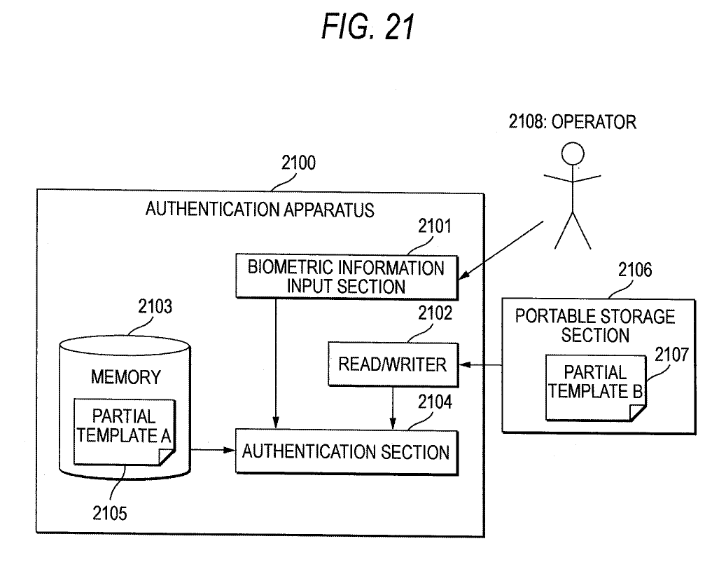

A storage section 102 and the vector computation section 500 typically are implemented as an LSI 2000 of an integrated circuit, as shown in FIG. 20. They may be put into one chip separately or may be put into one chip so as to contain some or all.

Here, an LSI is adopted, but an IC, a system LSI, a super LSI, or an ultra-LSI may be called depending on the integration scale difference.

The technique of putting into an integrated circuit is not limited to LSI and the sections may be implemented as a dedicated circuit or a general-purpose processor. An FPGA (Field Programmable Gate Array) that can be programmed after LSI is manufactured or a dynamic configurable processor wherein connection and setting of circuit cells in LSI can be dynamically reconfigured may be used.

Further, if a technology of putting into an integrated circuit replacing LSI advents because of the progress of the semiconductor technology or according to a derived different technology, the technology may be used to integrate the functional blocks, of course. It is possible to apply a biotechnology, etc., as a possibility.

### Third Embodiment

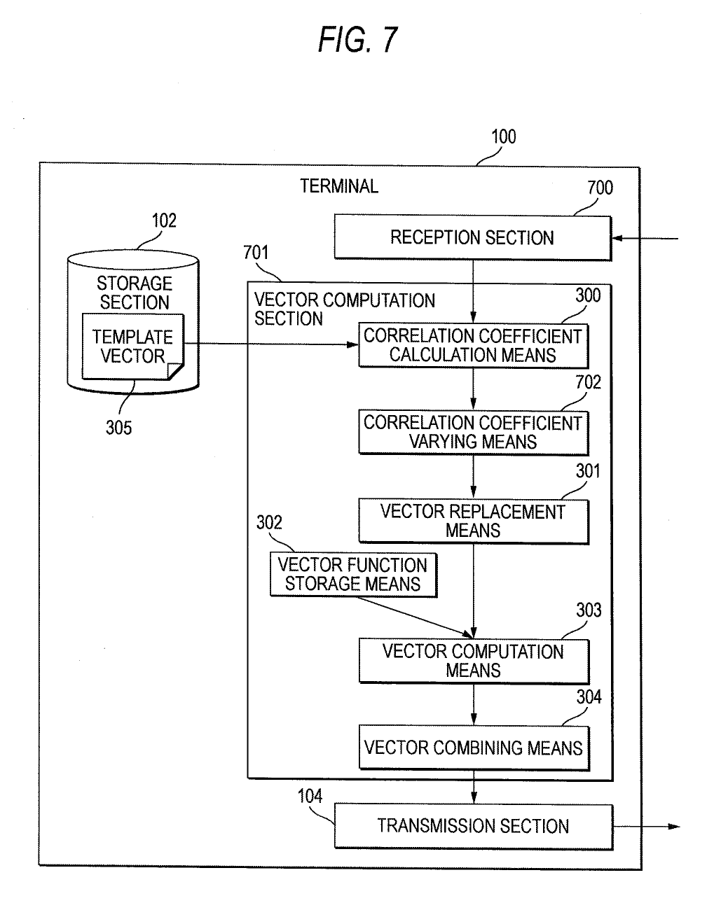

FIG. 7 shows the system configuration of a vector generation apparatus in a third embodiment of the invention.

In the first and second embodiments, the vector U which becomes the same as the calculated correlation coefficient E is generated. In the third embodiment, calculated E is further varied within the allowable range of the determination criterion and then a vector U is generated.

A terminal 100 differs from the above-described terminal in a reception section 700 for receiving a vector and the allowable range of a correlation coefficient using a communication network from the outside and a vector computation section 701 for calculating the correlation coefficient between two vectors, varying the value of the correlation coefficient within the allowable range, and generating a new vector matching the correlation coefficient.

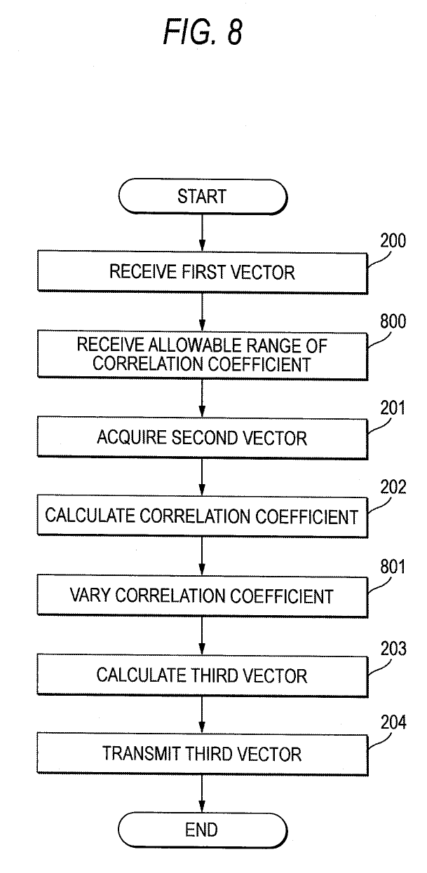

FIG. 8 shows an outline of a processing flow. Basically, the processing flow is that in FIG. 2 except that processing for varying the correlation coefficient is added.

In reception of the allowable range of a correlation coefficient at step 800, the reception section 700 receives information concerning the allowable range of a correlation coefficient using a communication network from the outside and passes the information to the vector computation section 701.

In varying the correlation coefficient at step 801, the correlation coefficient calculated at step 202 is varied within the allowable range of the correlation coefficient.

The processing flow outline differences have been described.

The vector computation section 701 differs from the vector computation section in the first or second embodiment in that it includes correlation coefficient varying means 702 for varying correlation coefficient E from the correlation coefficient E and the information concerning the allowable range of the correlation coefficient.

The detailed flow of the vector computation section 701 differs from the above-described flow in that after correlation coefficient calculation means 300 calculates a correlation coefficient, the correlation coefficient varying means 702 varies the correlation coefficient.

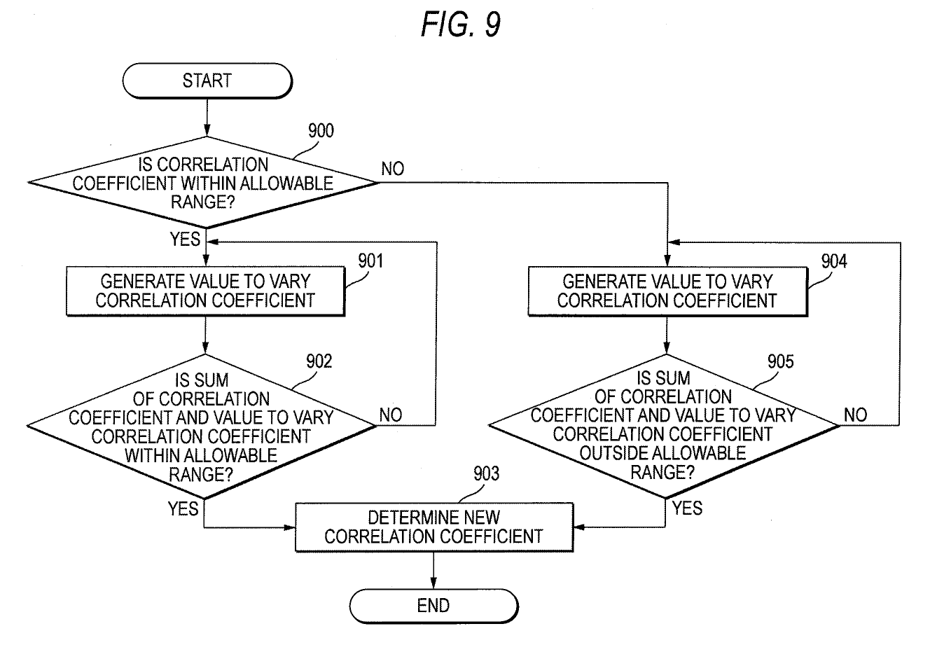

FIG. 9 shows a processing flow of varying the correlation coefficient.

At step 900, whether or not the calculated correlation coefficient E satisfies the allowable range of the correlation coefficient is determined. If the correlation coefficient E satisfies the allowable range, the process goes to step 901; if the correlation coefficient E does not satisfy the allowable range, the process goes to step 904.

At step 901, the value to vary the correlation coefficient is generated using a random number.

At step 902, whether or not the sum of the correlation coefficient and the value to vary the correlation coefficient is within the allowable range of the correlation coefficient is determined.

If the sum is within the allowable range, the process goes to step 903; if the sum is outside the allowable range, the process returns to step 901.

At step 903, since the generated value to vary the correlation coefficient satisfies the condition, the sum of the correlation coefficient and the generated value to vary the correlation coefficient is determined a new correlation coefficient, and the process is terminated.

If the process goes to step 904, the value to vary the correlation coefficient is generated using a random number, etc.

At step 905, whether or not the sum of the correlation coefficient and the value to vary the correlation coefficient is outside the allowable range of the correlation coefficient is determined.

If the sum is outside the allowable range, the process goes to step 903; if the sum is within the allowable range, the process returns to step 904.

For example, the case where the allowable range of the correlation coefficient E is equal to or greater than correlation coefficient E0 and equal to or less than E1 (E0<E1) will be discussed.

If E0≦E≦E1, the value to vary the correlation coefficient is α, α is generated at step 901, and whether or not E0≦E+α≦E1 is satisfied is determined at step 902.

A method of generating the value of E1−E0 from 0 at step 901 and determining whether or not the value of the E0 added to the value is equal to or less than E1 at step 902 is also available.

The processing flow of varying the correlation coefficient has been described.

For example, when the allowable range of the correlation coefficient is “allowing a value in the range of 0 to 5 as the correlation coefficient value,” in response to the calculated correlation coefficient value, if the original correlation coefficient is within the range, it is varied so as to satisfy the range of 0 to 5; if the original correlation coefficient is outside the range, it is varied in the range not satisfying 0 to 5.

If the correlation coefficient calculated in the embodiment is a part of the vector when an external determination is made, the correlation coefficient may be varied considering the ratio of the part to the whole vector.

For example, if the allowable range of the correlation coefficient is 0 or more and or less and the vector is 100 dimensions as a whole and the 50 dimensions of the vector are received, the number of dimensions is a half of the whole and therefore the correlation coefficient is varied in the range of 0 to 2.5, a half of the whole. However, consideration is not required if the allowable range matched with the received number of dimensions is received from the outside.

Accordingly, to receive a vector partially, the correlation coefficient can be varied so as not to cause the case where the user who should be able to be accepted is not accepted or the opposite case as the correlation coefficient E is varied.

As described above, after E as the criterion when a vector U is generated is varied within the allowable range of the determination criterion, the vector U is generated, so that the candidate range if an attempt is made to estimate the vector T from the vector U furthermore widens and it becomes furthermore difficult to estimate the vector T.

Particularly, to apply to biometric authentication, after the correlation coefficient is varied considering the allowable range, a vector different from the biometric template hard to invalidate if it leaks is generated and is transmitted to the outside and biometric authentication is conducted, so that it becomes difficult to estimate the biometric template using the vector transmitted to the outside.

### Fourth Embodiment

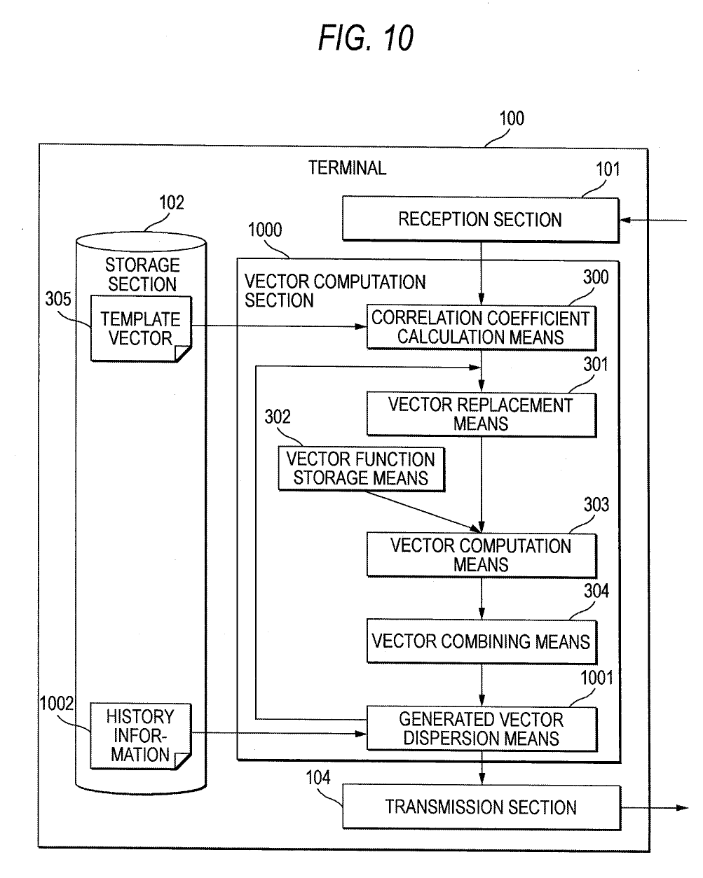

FIG. 10 shows the system configuration of a vector generation apparatus in a fourth embodiment of the invention.

Basically, the fourth embodiment is the same as the first and second embodiments except that the value of U transmitted to the outside is dispersed based on a history of a generated vector U. In so doing, it is made difficult to estimate a vector T using the vector U.

A terminal 100 differs from the above-described terminal in new storing of history information 1002 recording a vector U generated in the past and a vector computation section 1000 for calculating the correlation coefficient between two vectors, varying the value of the correlation coefficient, and dispersing and generating a new vector matching the correlation coefficient by referencing the history information 1002.

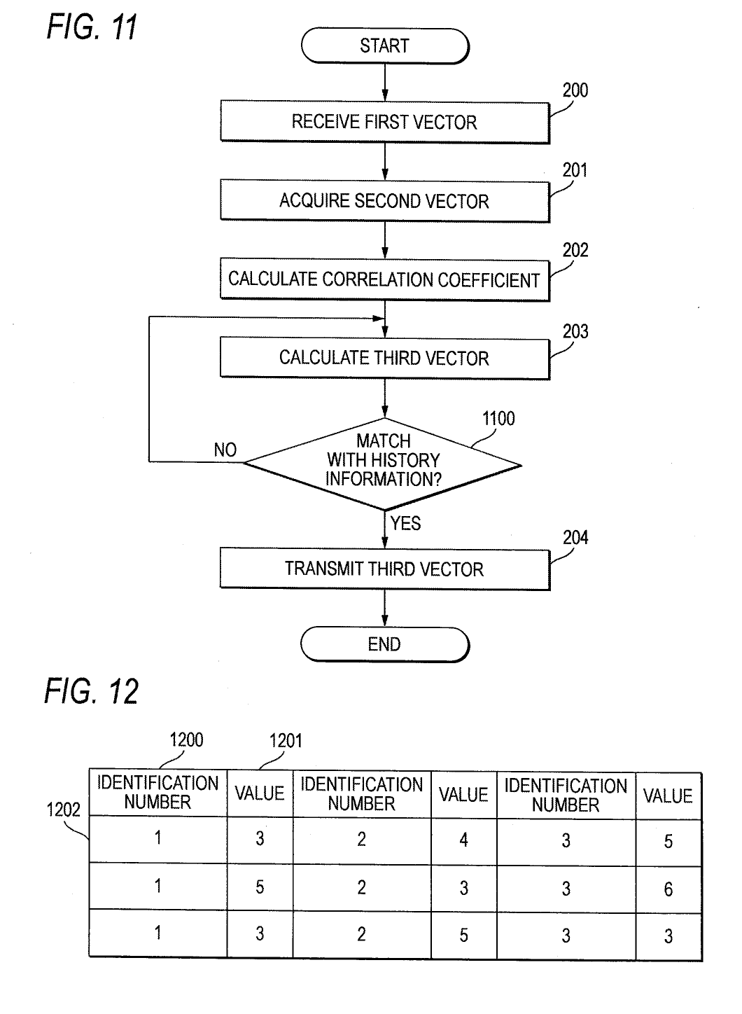

FIG. 11 shows an outline of a processing flow. Basically, the processing flow is that in FIG. 2 except that processing for dispersing the vector U is added.

In “history information match?” at step 1100, a third vector calculated at step 203 is checked for a match by referencing the history information 1002. If a match is found, a third vector is again calculated at step 203; if no match is found, the current generated vector U is recorded in the history information and the process goes to step 204.

The processing flow outline difference has been described.

The vector computation section 1000 differs from the above-described vector computation section in that it includes generated vector dispersion means 1001 for referencing the history information 1002 and dispersing the vector U.

FIG. 12 shows a specific example of the history information 1002.

For example, a horizontal row of pairs each of an identification number 120 indicating the how-manieth value of the vector and a value 1201 represents the vector U generated once, and as many horizontal rows as the number of generation times are arranged longitudinally, whereby the history information 1002 of the vectors U generated in the past can be represented.

First row 1202 represents that the first value of the vector is set to 3, the second value to 4, and the third value to 5.

When a new vector U is generated, for example, if the first component of the vector is 3, the second component is 4, and the third component is 5, the vector matches the first row 1202 when the history information is referenced. Thus, the vector U is again generated from the beginning.

As the determination criterion as to whether or not a match is found, the vector may be again generated from the beginning only when a complete match is found or the vector may be again generated from the beginning when a partial match is found; the determination criterion is determined depending on the extent to which the vector is to be dispersed.

As described above, the generated vector dispersion means 1001 disperses the vector U transmitted to the outside by using the vector stored in the history information, whereby the embodiment has the advantage that it is made difficult to estimate a vector T using analysis of a random number generation method.

In the embodiment, whether or not the generated vector matches is checked based on the history information and the vector U to be transmitted is dispersed, but a method of providing a set of previously dispersed vectors U and transmitting them in order to the outside is also available.

As the advantage, the need for generating the dispersed vector U on the spot is eliminated, so that the processing time at the authentication time is made shorter than that for generating the vector U on the spot.

A method of storing the generation date and time and preventing a match within a considerable time period is also available. A method of using the number of generation times and preventing a match within a considerable time period is also available.

As the advantage, if the storage capacity of the terminal is limited, the vector U history can be dispersed.

As described above, in the embodiment, the value of U to be transmitted to the outside is dispersed based on the history of the generated vector U and it is made difficult to estimate the vector T using the vector U.

### Fifth Embodiment

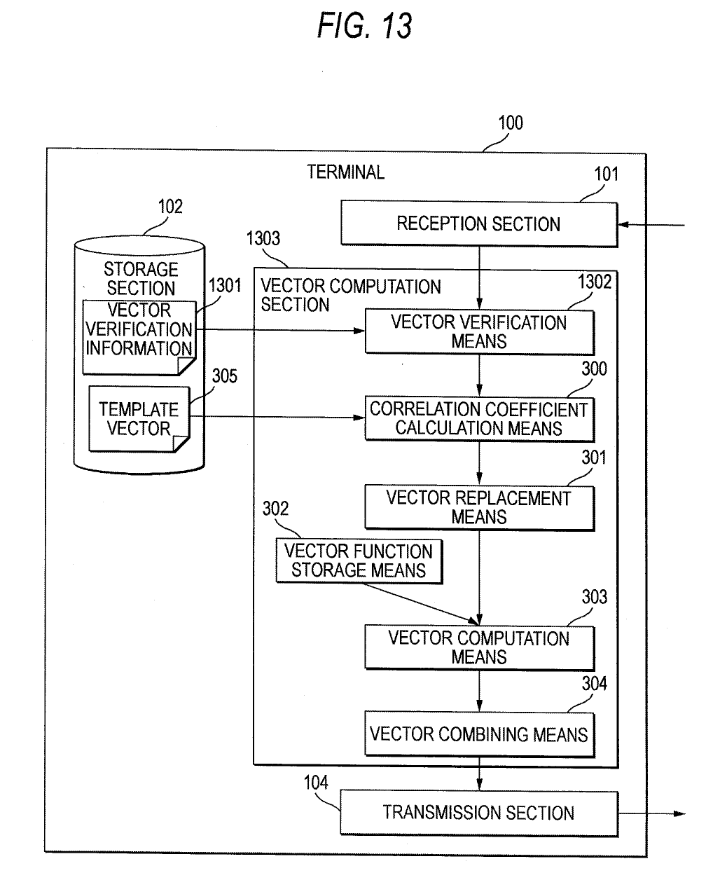

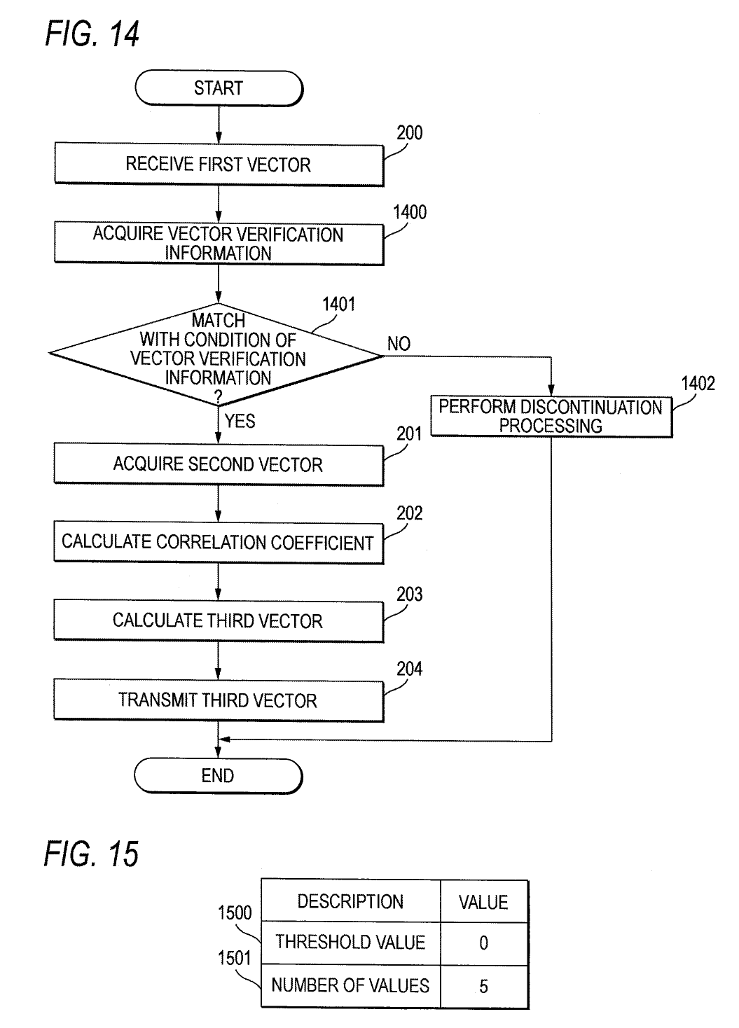

FIG. 13 shows the system configuration of a vector generation apparatus in a fifth embodiment of the invention.

Basically, the fifth embodiment is the same as the first and second embodiments except that a feature extraction vector R of the received first vector is verified based on vector verification information 1301 as the criterion for verifying whether or not the received first vector R is reliable.

A terminal 100 differs from the above-described terminal in new storing of vector verification information 1301 in a storage section 102 and a vector computation section 1303 for verifying the received first vector by referencing the verification information 1301.

FIG. 11 shows an outline of a processing flow.

Basically, the processing flow is that in FIG. 2 except that the first vector is verified and if the verification result indicates that the vector is reliable, vector generation processing is continued; if the verification result indicates that the vector is not reliable, vector generation processing is discontinued.

After the first vector is received at step 200, in acquisition of vector verification information at step 1400, the vector computation section 1303 acquires the vector verification information 1301 from the storage section 102.

In “match with vector verification information condition?” at step 1401, the vector computation section 1303 checks whether or not the received first vector matches the condition described in the vector verification information 1301.

If the vector does not match the condition, the process goes to acquisition of a second vector at step 201; if the vector matches the condition, the process goes to step 1402.

At step 1402, since the received first vector matches the condition described in the vector verification information 1301, processing of generating a third vector is discontinued and the process is terminated by transmitting a warning to the outside, etc.

As the criterion for verifying the first vector described in the vector verification information 1301, a method of checking the number of values equal to or less than a predetermined threshold value is available.

A threshold value 1500 indicating what value is to be used as the check criterion and number of values 1501 indicating how many values are contained in the vector are described in the vector verification information 1301, as shown in FIG. 15.

If (r1, 0, 0, 0, 0, 0), for example, is received as the vector R and a correlation coefficient E with a vector T is found using the inner product and the value of each element of the received vector is not verified, values other than the value of the first component of the vector R are all 0 and therefore a first component t1 of the vector T is found by calculation of t1=E/r1.

The vector computation section 1303 differs from the above-described vector computation section in that it includes vector verification means 1302 for referencing the vector verification information 1301 and verifying the first vector.

The vector verification means 1302 references the vector verification information 1301 and verifies the R vector of the first vector received by a reception section 101.

If (r1, 0, 0, 0, 0, 0), for example, is received as the vector R, the threshold value 1500 is 0 and the number of values 1501 is five and thus if the vector verification information 1301 is as shown in FIG. 15, the vector matches the determination criterion of the vector verification information and thus the generation processing of a third vector is discontinued.

As described above, the vector verification means 1302 verifies how many values contained in one range are contained.

At discontinuation processing step 1402, the vector verification means 1302 cancels vector generation and transmits a warning to the outside through a transmission section 104.

A vector not passing through authentication processing after transmission to the outside may be generated and transmitted, etc.

If the number of 0s of the received vectors is five, a warning is issued, no vector is transmitted, etc., whereby a vector U is generated from a vector with a large number of components of 0, so that there is the advantage that the vector T is prevented from being estimated.

As described above, the feature extraction vector of the received first vector is verified based on the vector verification information 1301, whereby it is made difficult to estimate the vector T from the vector U generated by operating the vector R.

A method of recording the contents of the first vector received K times (K is a natural number) in the past in the vector verification information 1301 and checking whether or not a match with the recorded vector is found is also available.

This method has the advantage that the vector T is prevented from being estimated from the distribution of the vectors U generated from the same first vector. In this case, the vector verification means 1302 records the value of the received first vector in the vector verification information 1301.

### Sixth Embodiment

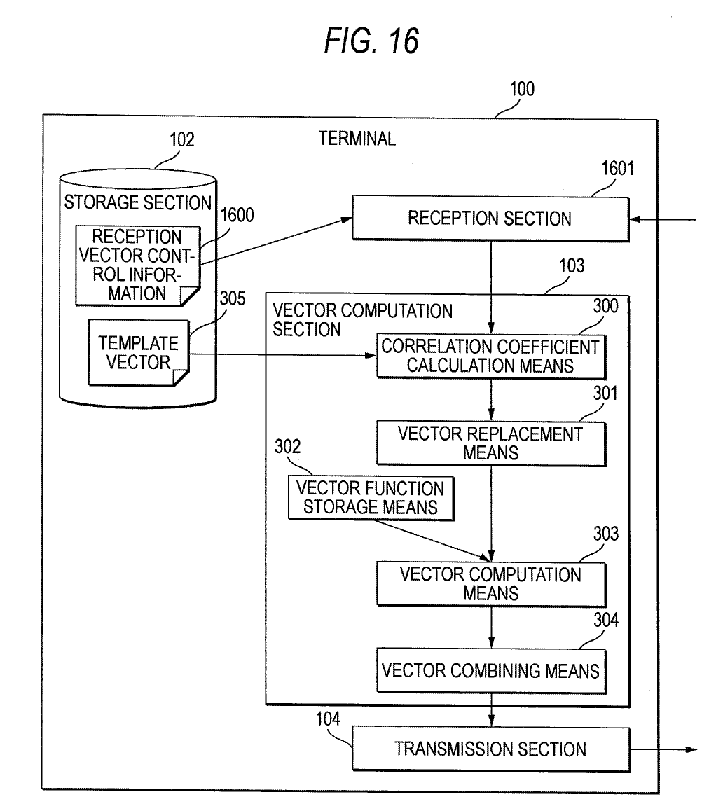

FIG. 16 shows the system configuration of a vector generation apparatus in a sixth embodiment of the invention.

Basically, the sixth embodiment is the same as the first and second embodiments except that a reception section 1601 selectively receives a feature extraction vector R of a first vector based on reception vector control information 1800 describing information concerning the elements of the first vector to be received.

A terminal 100 differs from the above-described terminal in that reception vector control information 1600 is newly stored in a storage section 102 and the reception section 1601 receives the first vector based on the reception vector control information 1600.

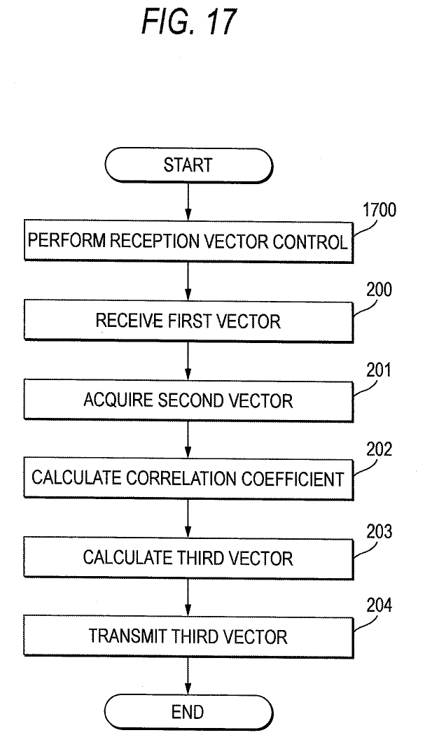

FIG. 17 shows an outline of a processing flow. Basically, the processing flow is that in FIG. 2 except that processing of controlling reception of the first vector is added.

At step 1700, the reception section 16001 controls the first vector received based on the reception vector control information 1600.

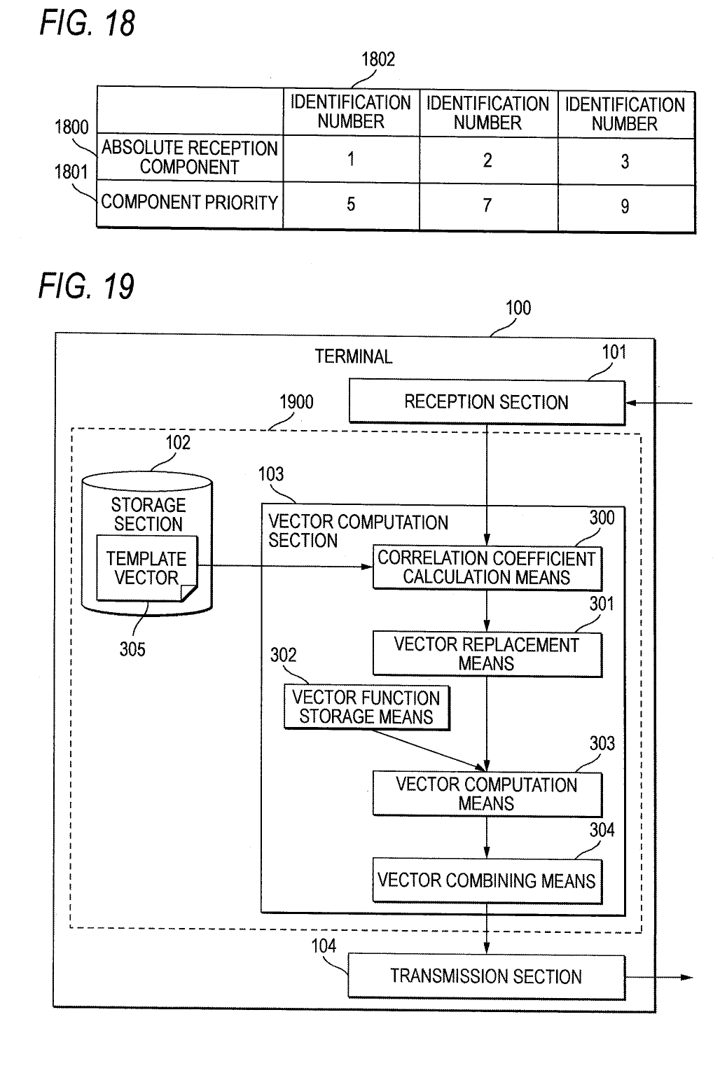

FIG. 18 shows a specific example of the reception vector control information 1600.

The reception vector control information 1600 is made up of an absolute reception component 1800 indicating the component to be inevitably received in the first vector and a component priority indicating the priority of each component in the whole of the first vector.

In the example in FIG. 18, the absolute reception components 1800 are the first, second, and third components and the component priority 1801 indicates that a high priority is assigned to the fifth, seventh, and ninth components in order, as indicated by an identification number 1802 representing the how-manieth component of the vector.

In this case, the reception section 1700 always receives the first, second, and third components and to receive additional components, receives the components of the first vector preferentially in the order of the fifth, seventh, and ninth components.

A server is previously authenticated and the reliability of the server is determined and the number of dimensions of the received vector is determined by the reliability. The values of the components of the vector T corresponding to unreceived components are not changed.

To determine the reliability of the server, for example, grading information of each server provided by a reliable third party is used or the number of chains to the route of a certificate of a public key used for authentication is used as the criterion for the reliability.

The processing after reception of the first vector is similar to that in the first and second embodiments.

The values of the components of the vector not received are transmitted as they are.

As described above, the reception section 1601 selectively receives the feature extraction vector R of the first vector based on the reception vector control information 1600, whereby after the components at high security level are always received, the third vector is generated and the components of the second vector at high security level can be protected preferentially.

For a vector with a large number of dimensions, the components at high security level are preferentially selected and received and the third vector is generated, whereby it is made possible to preferentially protect the components of the second vector at high security level.

While the invention has been described in detail with reference to the specific embodiments, it will be obvious to those skilled in the art that various changes and modifications can be made without departing from the spirit and the scope of the invention.

This application is based on Japanese Patent Application (No. 2005-050937) filed on Feb. 25, 2005, which is incorporated herein by reference.

### INDUSTRIAL APPLICABILITY

The biometric template transmitted by the terminal to the outside is converted so that the collation result is maintained in the terminal and it is difficult to restore to the original template and thus can be used only in the authentication on the spot. Therefore, the invention has the advantage that if the provided biometric template leaks from the server, it is difficult to make secondary use of the biometric template for authentication, etc., and safety is provided; the invention can be applied to a mobile terminal, a personal computer, and a storage device capable of storing secret information to be protected.

1: A vector generation apparatus for generating data satisfying a given requirement, comprising:
a reception section for receiving a first vector R of N (N is a natural number of two or more) dimensions from a server connected to said apparatus so that information can be transmitted;
a storage section for storing a second vector T of N dimensions;
a vector computation section for calculating a correlation coefficient E between the first vector R and the second vector T and generating a third vector U different from the second vector T, with the correlation coefficient matching the correlation coefficient E; and
a transmission section for transmitting the third vector U to the server.

2: The vector generation apparatus as claimed in claim 1, wherein said vector computation section comprises:
correlation coefficient calculation means for calculating the correlation coefficient E using a function for calculating the correlation coefficient between the first vector R and the second vector T;
vector replacement means for generating a vector Tr and a variable vector Ty from the second vector T;
vector function storage means for storing a vector function G to find the variable vector Ty with the value of correlation coefficient becoming the value of the correlation coefficient between the first vector T and the second vector R in the variable vector Ty;
vector computation means for calculating the variable vector Ty with the value of correlation coefficient becoming the value of the correlation coefficient between the first vector T and the second vector R at least with the correlation coefficient E, the first vector R, and the vector Tr as variables of the vector function G; and
vector combining means for generating the variable vector Ty calculated in the vector computation means as a vector U.

3: The vector generation apparatus as claimed in claim 1, wherein said vector computation section comprises:
correlation coefficient calculation means for using a function V=F(X, Y) for calculating a correlation coefficient V between a first variable vector X and a second variable vector Y to calculate the value V of the function F as the correlation coefficient E where the first variable vector x is the first vector R and the second variable vector Y is the second vector T;
vector replacement means for selecting an n-dimensional partial vector Tn with any n (a natural number smaller than N) of the second vector T as elements, replacing the selected n-dimensional partial vector Tn with an n-dimensional vector Tr different from the vector Tn, and replacing an (N−n)-dimensional partial vector having other (N−n) of the second vector T as elements with an (N−n)-dimensional variable vector Ty, thereby generating the third vector U;
vector function storage means for storing a vector function G to find the variable vector Ty satisfying a relational expression E=F(R, U);
vector computation means for calculating a vector W=G(E, R, Tr) with the correlation coefficient E, the first vector R, and the vector Tr as variables of the vector function G; and
vector combining means for generating the third vector U provided by replacing the variable vector Ty with the vector W.

4: The vector generation apparatus as claimed in claim 1, wherein said vector computation section comprises:
correlation coefficient calculation means for using a function V=F(X, Y) for calculating a correlation coefficient V between a first variable vector X and a second variable vector Y to calculate the value V of the function F as the correlation coefficient E where the first variable vector X is the first vector R and the second variable vector Y is the second vector T;
vector replacement means for selecting an n-dimensional partial vector Tn with any n (a natural number smaller than N) of the second vector T as elements, replacing the selected n-dimensional partial vector Tn with an n-dimensional vector Tr different from the vector Tn, and replacing an (N−n)-dimensional partial vector having other (N−n) of the second vector T as elements with an (N−n)-dimensional variable vector Ty, thereby generating the third vector U;
vector function storage means for storing a vector function G to find the variable vector Ty satisfying a relational expression E=F(R, U);
vector computation means for calculating a vector W=G(E, T, R, Tr) with the correlation coefficient E, the first vector R, the second vector T, and the vector Tr as variables of the vector function G; and
vector combining means for generating the third vector U provided by replacing the variable vector Ty with the vector W.

5: The vector generation apparatus as claimed in claim 1, wherein said reception section receives information of the allowable range of the correlation coefficient E, and
said vector computation section has correlation coefficient varying means for varying the correlation coefficient E in response to the allowable range.

6: The vector generation apparatus as claimed in claim 1, wherein said storage section stores history information of the third vector U generated by said vector computation section, and
said vector computation section has generated vector dispersion means for controlling so as to generate the third vector U not recorded in the history information.

7: The vector generation apparatus as claimed in claim 1, wherein said storage section stores vector verification information of information as the criterion for verifying the first vector R, and
said vector computation section has vector verification means for verifying the first vector R with the vector verification information as the criterion and changing the generation method of the third vector U in response to the verification result.

8: The vector generation apparatus as claimed in claim 1, wherein said storage section stores the security level of each component of the first vector R and reception vector control information of information of an action taking method responsive to the security level, and said reception section selects components of the first vector R with the reception vector control information as the criterion.

9: A vector generation method in an apparatus having a computation function, said vector generation method comprising the steps executed by the apparatus, of:
a first step of receiving a first vector R from a server connected to the apparatus so that information can be transmitted;
a second step of acquiring a second vector T from a storage section for storing the second vector;
a third step of calculating a correlation coefficient E between the first vector R and the second vector T;
a fourth step of generating a third vector U different from the second vector T, with the correlation coefficient matching the correlation coefficient E; and
a fifth step of transmitting the third vector U to the server.

10: The vector generation method as claimed in claim 9, comprising the steps of:
to calculate the correlation coefficient E in said third step, setting a function for calculating a correlation coefficient V between a first variable vector X and a second variable vector Y as V=F(X, Y) and calculating the value V of the function F as the correlation coefficient E where the first variable vector X is the first vector R and the second variable vector Y is the second vector T;
in said fourth step, replacing an n-dimensional partial vector Tn with any n (a natural number smaller than N) of the second vector T as elements with an n-dimensional vector Tr different from the vector Tn and replacing an (N-n)-dimensional partial vector having other (N−n) of the second vector T as elements with an (N−n)-dimensional variable vector Ty, thereby generating the third vector U;
acquiring a vector function G to find the variable vector Ty satisfying a relational expression E=F(R, U);
calculating a vector W according to W=G(E, R, Tr) with the correlation coefficient E, the first vector R, and the vector Tr as variables of the vector function G; and
generating the third vector U provided by replacing the variable vector Ty with the vector W.

11: An integrated circuit having a vector device for generating data satisfying a given requirement, the vector generation device comprising:
a storage section for storing a second vector T of N dimensions; and
a vector computation section for calculating a correlation coefficient E between a first vector R of N (N is a natural number of two or more) dimensions received from a server connected to the apparatus so that information can be transmitted and the second vector T and generating a third vector U different from the second vector T, with the correlation coefficient matching the correlation coefficient E.

12: The integrated circuit as claimed in claim 11, wherein the vector computation section comprises correlation coefficient calculation means for using a function V=F(X, Y) for calculating a correlation coefficient V between a first variable vector X and a second variable vector Y to calculate the value V of the function F as the correlation coefficient E where the first variable vector X is the first vector R and the second variable vector Y is the second vector T;
vector replacement means for selecting an n-dimensional partial vector Tn with any n (a natural number smaller than N) of the second vector T as elements, replacing the selected n-dimensional partial vector Tn with an n-dimensional vector Tr different from the vector Tn, and replacing an (N−n)-dimensional partial vector having other (N−n) of the second vector T as elements with an (N−n)-dimensional variable vector Ty, thereby generating the third vector U;
vector function storage means for storing a vector function G to find the variable vector Ty satisfying a relational expression E=F(R, U);
vector computation means for calculating W=G(E, R, Tr) with the correlation coefficient E, the first vector R, and the vector Tr as variables of the vector function G; and
vector combining means for generating the third vector U provided by replacing the variable vector Ty with the vector W.

13: The integrated circuit as claimed in claim 11, wherein the vector computation section comprises correlation coefficient calculation means for using a function V=F(X, Y) for calculating a correlation coefficient V between a first variable vector X and a second variable vector Y to calculate the value V of the function F as the correlation coefficient E where the first variable vector X is the first vector R and the second variable vector Y is the second vector T;
vector replacement means for selecting an n-dimensional partial vector Tn with any n (a natural number smaller than N) of the second vector T as elements, replacing the selected n-dimensional partial vector Tn with an n-dimensional vector Tr different from the vector Tn, and replacing an (N−n)-dimensional partial vector having other (N−n) of the second vector T as elements with an (N−n)-dimensional variable vector Ty, thereby generating the third vector U;
vector function storage means for storing a vector function G to find the variable vector Ty satisfying a relational expression E=F(R, U);
vector computation means for calculating W=G(E, T, R, Tr) with the correlation coefficient E, the first vector R, the second vector T, and the vector Tr as variables of the vector function G; and
vector combining means for generating the third vector U provided by replacing the variable vector Ty with the vector W.

14: The vector generation apparatus as claimed in claim 2 used for biometric authentication, wherein
the first vector R is a feature extraction vector provided by extracting a vector of the feature amount from biometric information of a user acquired with a sensor, and that
the second vector T is a biometric template subjected to previous registration processing and used as a criterion when whether or not one user is the person in question is judged.

15: The vector generation apparatus as claimed in claim 3 used for biometric authentication, wherein
the first vector R is a feature extraction vector provided by extracting a vector of the feature amount from biometric information of a user acquired with a sensor, and that
the second vector T is a biometric template subjected to previous registration processing and used as a criterion when whether or not one user is the person in question is judged.

16: The vector generation apparatus as claimed in claim 4 used for biometric authentication, wherein
the first vector R is a feature extraction vector provided by extracting a vector of the feature amount from biometric information of a user acquired with a sensor, and that
the second vector T is a biometric template subjected to previous registration processing and used as a criterion when whether or not one user is the person in question is judged.
